(19) United States
(12) Patent Application Publication
(10) Pub. No.: US 2016/0264001 A1
(43) Pub. Date: Sep. 15, 2016

(54) VEHICLE CONTROL APPARATUS

(71) Applicant: TOYOTA JIDOSHA KABUSHIKI KAISHA, Toyota-shi, Aichi (JP)

(72) Inventors: Shintaro TSUJII, Chiryu-shi, Aichi-ken (JP); Yoshitaka NIIMI, Susono-shi, Shizuoka-ken (JP); Masaki OKAMURA, Toyota-shi, Aichi-ken (JP); Wanleng ANG, Gotenba-shi, Shizuoka-ken (JP); Hideaki YAGUCHI, Toyota-shi, Aichi-ken (JP); Keisuke MORISAKI, Toyota-shi, Aichi-ken (JP); Hichirosai OYOBE, Toyota-shi, Aichi-ken (JP)

(73) Assignee: TOYOTA JIDOSHA KABUSHIKI KAISHA, Toyota-shi, Aichi-ken (JP)

(21) Appl. No.: 15/034,049

(22) PCT Filed: Oct. 31, 2014
(86) PCT No.: PCT/JP2014/079658

§ 371 Date: May 3, 2016

(30) Foreign Application Priority Data
Nov. 5, 2013 (JP) 2013-229737

(51) Int. Cl. B60L 7/00; H02P 3/22; H02P 27/08; B60L 15/20

(52) U.S. Cl. CPC B60L 7/003; B60L 15/2009; H02P 3/22; H02P 27/08

(57) ABSTRACT

A vehicle control apparatus is provided with an upper controlling device and a lower controlling device. The upper controlling device has: a first determining device configured to determine whether or not the number of revolutions of a three-phase AC motor is less than or equal to a predetermined threshold value and whether or not a stop operation which can stop the vehicle is performed; a second determining device configured to determine that the vehicle is stopped if it is determined that the number of revolutions of the three-phase AC motor is less than or equal to the predetermined threshold value and that the stop operation is performed; and a commanding device configured to output a particular control command for setting the state of a power converter to a particular state if it is determined that the vehicle is stopped. The lower controlling device controls the power converter to be in the particular state after a lapse of a predetermined period from the reception of the particular control command.

### TECHNICAL FIELD

The present invention relates to, for example, a vehicle control apparatus configured to control a vehicle provided with an electric motor.

### BACKGROUND ART

Recently, the vehicle provided with the electric motor (or a so-called motor) has been attracting attention. As an example of the vehicle provided with the electric motor as described above, there is known a hybrid vehicle provided with both the electric motor and an internal combustion engine (e.g. refer to Patent document 1).

The Patent document 1 discloses a technology in which three-phase short-circuit control of the electric motor is performed to stop the rotation of the internal combustion engine at an early stage if the number of revolutions of the internal combustion engine is less than the predetermined number of revolutions in the hybrid vehicle as described above.

### PRIOR ART DOCUMENTS

### Patent Documents

Patent document 1: Japanese Patent Application Laid Open No. 2006-288051

### SUMMARY OF THE INVENTION

### Subject to be Solved by the Invention

By the way, if the three-phase short-circuit control is performed, sufficient torque to be a braking force in the electric motor is generated in a high vehicle speed region (i.e. in a region in which the number of revolutions of the electric motor is high); however, the electric motor cannot rotate in a low vehicle speed region or during the stop of a vehicle (i.e. in a region in which the number of revolutions of the electric motor is extremely low or zero), resulting in nearly zero (or completely zero) rotation, and the output torque of the electric motor becomes zero. Thus, for example, if the three-phase short-circuit control is performed immediately before the vehicle stops in a case where the torque of the electric motor is not zero, then, the torque of the electric motor suddenly decreases, and that gives a driver of the vehicle a sense of torque falling, which is technically problematic.

The above is exemplified as one example of the subject or problem to be solved by the present invention. It is therefore an object of the present invention to provide a vehicle control apparatus configured to prevent the occurrence of the sense of torque falling, during the three-phase short-circuit control.

### Means for Solving the Subject

The above object of the present invention can be achieved by a vehicle control apparatus configured to control a vehicle, the vehicle provide with: a three-phase alternating current (AC) motor configured to driven at the number of revolutions which synchronizes with the number of revolutions of a drive shaft of the vehicle; and a power converter comprising first switching elements and second switching elements for respective three phases of the three-phase AC motor, each first switching element and each second switching element being connected in series, the power converter being configured to convert electric power supplied to the three-phase AC motor from direct current (DC) power to AC power, said vehicle control apparatus provide with: an upper controlling device configured to output a command for controlling an operation of the three-phase AC motor; and a lower controlling device configured to control the operation of the three-phase AC motor by controlling a state of the power converter according to the command outputted from the upper controlling device, wherein said upper controlling deice has: a first determining device configured to determine whether or not the number of revolutions of the three-phase AC motor is less than or equal to a predetermined threshold value and whether or not a stop operation which can stop the vehicle is performed; a second determining device configured to determine that the vehicle is stopped if the first determining device determines that the number of revolutions of the three-phase AC motor is less than or equal to the predetermined threshold value and that the stop operation is performed; and a commanding device configured to output to said lower controlling device a particular control command for setting the state of the power converter to a particular state in which all of one of the first switching elements and the second switching elements are OFF and at least one of the other of the first switching elements and the second switching elements is ON, if the second determining device determines that the vehicle is stopped, and said lower controlling device controls the power converter to be in the particular state after a lapse of a predetermined period from reception of the particular control command.

According to the vehicle control apparatus of the present invention, the vehicle provided with the three-phase AC motor can be controlled. The three-phase AC motor is disposed such that the number of revolutions of the three-phase AC motor synchronizes with the number of revolutions of the drive shaft of the vehicle. There, the “state in which the number of revolutions of the three-phase AC motor synchronizes with the number of revolutions of the drive shaft” means a state in which the number of revolutions of the three-phase AC motor and the number of revolutions of the drive shaft have a correlation. Typically, the “state in which the number of revolutions of the three-phase AC motor synchronizes with the number of revolutions of the drive shaft” means a state in which the number of revolutions of the three-phase AC motor is proportional to the number of revolutions of the drive shaft (i.e. a state in which the number of revolutions of the three-phase AC motor×K (wherein K is an arbitrary constant)=the number of revolutions of the drive shaft). The “state in which the number of revolutions of the three-phase AC motor synchronizes with the number of revolutions of the drive shaft” may be realized by directly coupling the rotating shaft of the three-phase AC motor with the drive shaft. Alternatively, the “state in which the number of revolutions of the three-phase AC motor synchronizes with the number of revolutions of the drive shaft” may be realized by indirectly coupling the rotating shaft of the three-phase AC motor with the drive shaft via some mechanical mechanism (e.g. a reduction gear mechanism).

Moreover, the three-phase AC motor is driven by using the electric power supplied from the power converter (i.e. the AC power). In order to supply the electric power to the three-phase AC motor, the power converter is provided with the first switching elements (e.g. switching elements electrically connected between high voltage side terminals of a power supply and the three-phase AC motor) and the second switching elements (e.g. switching elements electrically connected between low voltage side terminals of the power supply and the three-phase AC motor) for the respective three phases of the three-phase AC motor, wherein each first switching element and each second switching element are connected in series. In other words, the power converter is provided with the first and second switching elements disposed in a U phase, the first and second switching elements disposed in a V phase, and the first and second switching elements disposed in a W phase.

The vehicle control apparatus of the present invention is provided with the upper controlling device and the lower controlling device, as main constituents. The upper controlling device is configured, for example, as an upper electronic control unit (ECU) configured to control the operation of the entire vehicle, and is configured to output to the lower controlling device the command for controlling the operation of the three-phase AC motor. Moreover, the upper controlling device may be configured to output a command for a part of the vehicle other than the three-phase AC motor. On the other hand, the lower controlling device is configured as an ECU only for the three-phase AC motor, and controls the operation of the three-phase AC motor by controlling the state of the power converter according to the command outputted from the upper controlling device.

According to the upper controlling device and the lower controlling device as described above, for example, if the operation of the three-phase AC motor is controlled, firstly, the command for controlling the operation of the three-phase AC motor (e.g. a command toque value, etc.) is outputted from the upper controlling device to the lower controlling device. Then, the lower controlling device, which receives the command, controls the state of the power converter according to the command. As a result, the supply of the electric power to the three-phase AC motor is controlled, and the operation of the three-phase AC motor is actually controlled.

The upper controlling device of the present invention has the first determining device and the second determining device to determine whether or not the vehicle provided with the three-phase AC motor is stopped.

The first determining device performs a determination operation based on the number of revolutions of the three-phase AC motor. Specifically, the first determining device determines whether or not the number of revolutions of the three-phase AC motor is less than or equal to the predetermined threshold value. In addition, the first determining device performs a determination operation based on the presence or absence of the stop operation which can stop the vehicle. Specifically, the first determining device determines whether or not the stop operation which can stop the vehicle is performed.

The second determining device determines whether or not the vehicle is stopped, on the basis of a determination result of the first determining device. Specifically, the second determining device determines that the vehicle is stopped if the first determining device determines that the number of revolutions of the three-phase AC motor is less than or equal to the predetermined threshold value and that the stop operation is performed. On the other hand, the second determining device may determine that the vehicle is not stopped if the first determining device determines that the number of revolutions of the three-phase AC motor is not less than or equal to the predetermined threshold value. In the same manner, the second determining device may determine that the vehicle is not stopped if the first determining device determines that the stop operation is not performed.

According to the first determining device and the second determining device described above, it can be determined whether or not the vehicle is stopped on the basis of not only the number of revolutions of the three-phase AC motor but also the presence or absence of the stop operation. Therefore, the vehicle control apparatus of the present invention can determine whether or not the vehicle is stopped, relatively accurately, in comparison with a vehicle control apparatus in a first comparative example configured to determine that the vehicle is stopped if the number of revolutions of an internal combustion engine is less than or equal to a predetermined threshold value, wherein the detection accuracy of the number of revolutions of the internal combustion engine can be lower than that of the number of revolutions of the three-phase AC motor. In addition, the vehicle control apparatus of the present invention can determine whether or not the vehicle is stopped, relatively accurately, in comparison with a vehicle control apparatus in a second comparative example configured to determine that the vehicle is stopped if the number of revolutions of the three-phase AC motor is less than or equal to the predetermined threshold value without determining whether or not the stop operation is performed.

The second determining device may determine whether or not the vehicle is stopped on the basis of a duration in the state in which the first determining device determines that the number of revolutions of the three-phase AC motor is less than or equal to the predetermined threshold value and that the stop operation is performed. In other words, the second determining device may determine that the vehicle is stopped if the duration is greater than or equal to a predetermined period. According to the determination as described above, the second determining device can determine whether or not the vehicle is stopped, more accurately. In particular, the second determining device can determine whether or not the vehicle is stopped, more accurately, for example, even if the number of revolutions of the three-phase AC motor is subject to hunting (or is not fixed, or varies).

Moreover, in the present invention, the upper controlling device has the commanding device configured to output the command for controlling the operation of the three-phase AC motor (i.e. for controlling the state of the power converter). The commanding device outputs to the lower controlling device the particular control command for controlling the state of the power converter to the particular state (typically, to be fixed in the particular state) if the second determining device determines that the vehicle is stopped. Here, the “particular state” is a state in which all of one of the first switching elements and the second switching elements are OFF (or in a disconnection state) and at least one of the other of the first switching elements and the second switching elements is ON (or in a connection state).

On the other hand, if receiving the particular control command outputted from the upper controlling device, the lower controlling device of the present invention controls the power converter to be in the particular state (hereinafter referred to as “three-phase short-circuit control” as occasion demands). By setting the power converter to be in the particular state, it is possible to generate a braking force on the three-phase AC motor, and for example, it is possible to preferably perform the stop control of the vehicle. In a vehicle provided with another three-phase AC motor in addition to the three-phase AC motor of the present invention, a power converter corresponding to the other three-phase AC motor may also be controlled to be in the particular state.

In particular, however, the lower controlling device of the present invention performs the three-phase short-circuit control after a lapse of the predetermined period from the reception of the particular control command. In other words, the lower controlling device does not control the power converter to be in the particular state immediately after the reception of the particular control command, but waits for the predetermined period to control the power converter to be in the particular state.

Here, if the three-phase short-circuit control is performed, sufficient torque to obtain the braking force is generated in a high vehicle speed region (i.e. in a region in which the number of revolutions of the three-phase AC motor is high); however, the three-phase AC motor cannot rotate in a low vehicle speed region or during the stop of the vehicle (i.e. in a region in which the number of revolutions of the electric motor is extremely low or zero), resulting in nearly zero (or completely zero) rotation, and the output torque of the three-phase AC motor becomes zero. Thus, for example, if the particular state of the power converter is realized immediately before the vehicle stops in a case where the torque of the three-phase AC motor is not zero, then, the torque of the three-phase AC motor suddenly decreases, and that gives a driver of the vehicle the sense of torque falling.

In particular, if the two controlling devices (i.e. the upper controlling device and the lower controlling device) are provided as in the present invention, even if the command for setting the torque of the three-phase AC motor to be zero is given from the upper controlling device, there can be some cases where the command torque from the lower controlling device for the three-phase AC motor is not zero, for example, due to a communication lag between the upper controlling device and the lower controlling device, a smoothing or blurring effect by a filter, or the like. Thus, even if the command torque is zero on the upper controlling device, the actual torque of the three-phase AC motor is possibly not zero. Therefore, the realization of the particular state immediately after the reception of the particular control command highly likely causes the sense of torque falling described above.

In the present invention, however, as described above, the three-phase short-circuit control is performed after a lapse of the predetermined period from the reception of the particular control command. In other words, the particular state of the power converter is realized after the torque of the three-phase AC motor actually becomes zero. To put it differently, the “predetermined period” of the present invention is set as a period from when the particular control command is outputted from the upper controlling device to when the torque of the three-phase AC motor actually becomes zero (or the command torque from the lower controlling device becomes zero). The predetermined period may be obtained and set, theoretically, experimentally, or experientially, for example, in view of the length of the communication lag between the upper controlling device and the lower controlling device, filter characteristics, or the like.

As explained above, according to the vehicle control apparatus of the present invention, it is possible to prevent the occurrence of the sense of torque falling, by performing the three-phase short-circuit control after a lapse of the predetermined period from the particular control command. It is therefore possible to preferably perform the stop control without reducing drivability.

In one aspect of the vehicle control apparatus of the present invention, wherein said lower controlling device performs the control to set torque of the three-phase AC motor to be zero after the reception of the particular control command, and then performs the control to set the power converter to be in the particular state.

According to this aspect, the three-phase short-circuit control is performed after the torque of the three-phase AC motor is actually set to be zero. In other words, unless the torque of the three-phase AC motor is controlled to be zero, the three-phase short-circuit control is not performed. It is thus possible to certainly prevent the occurrence of the sense of torque falling caused by the implementation of the three-phase short-circuit control in a state in which the torque of the three-phase AC motor is not zero.

In an aspect in which performs the control to set torque of the three-phase AC motor to be zero, and then performs the control to set the power converter to be in the particular state, as described above, said lower controlling device may be have an addition controlling device configured to perform addition control for adding the torque of the motor, independently of the command from said upper controlling device, and the addition controlling device may be stop the addition control until the control for setting the power converter to be in the particular state if the particular control command is received.

In this case, even if the command for setting the torque of the three-phase AC motor to be zero is outputted from the upper controlling device, the addition control by the addition controlling device for the torque of the three-phase AC motor (i.e. control for changing a torque command value of the motor) is performed, for example, in view of an influence of disturbance or the like. The implementation of the addition control as described above can cause the case where the command torque by the lower controlling device is not zero even if the command torque of the upper controlling device is zero.

Particular in this aspect, if the particular control command is outputted from the upper controlling device, the addition control described above is stopped. Thus, even in a situation in which the addition control is normally determined to be performed, the addition control is not performed if the particular control command is outputted. As a result, after the output of the particular control command, the command torque of the lower controlling device can be certainly brought close to zero. In this manner, since the command torque of the lower controlling device does not become zero regardless of the output of the particular control command, it is possible to avoid a state in which the three-phase short-circuit control cannot be performed.

The operation and other advantages of the present invention will become more apparent from embodiments explained below.

### BRIEF DESCRIPTION OF DRAWINGS

FIG. 1 is a block diagram illustrating a configuration of a vehicle in a first embodiment.

FIG. 2 is a flowchart illustrating a flow of a stop determination operation in the first embodiment.

FIG. 3 is a timing chart illustrating the number of revolutions, a brake pedal pressing force value, the satisfaction or non-satisfaction of a stop determination condition, and a stop determination result of a vehicle.

FIG. 4 is a chart illustrating changes in a torque command value and actual torque when the vehicle in the first embodiment stops.

FIG. 5 is a chart illustrating changes in the torque command value and the actual torque when a vehicle in a first comparative example stops.

FIG. 6 is a flowchart illustrating a flow of the stop determination operation in a second embodiment.

FIG. 7 is a chart illustrating changes in the torque command value and the actual torque when a vehicle in the second embodiment stops.

FIG. 8 is a chart illustrating a change in the torque command value when a vehicle in a second comparative example stops.

FIG. 9 is a chart illustrating a change in the torque command value when a vehicle in a third embodiment stops.

FIG. 10 is a block diagram illustrating a configuration of a vehicle in a fourth embodiment.

### MODE FOR CARRYING OUT THE INVENTION

Hereinafter, embodiments of the vehicle control apparatus of the present invention will be explained with reference to the drawings.

### (1) First Embodiment

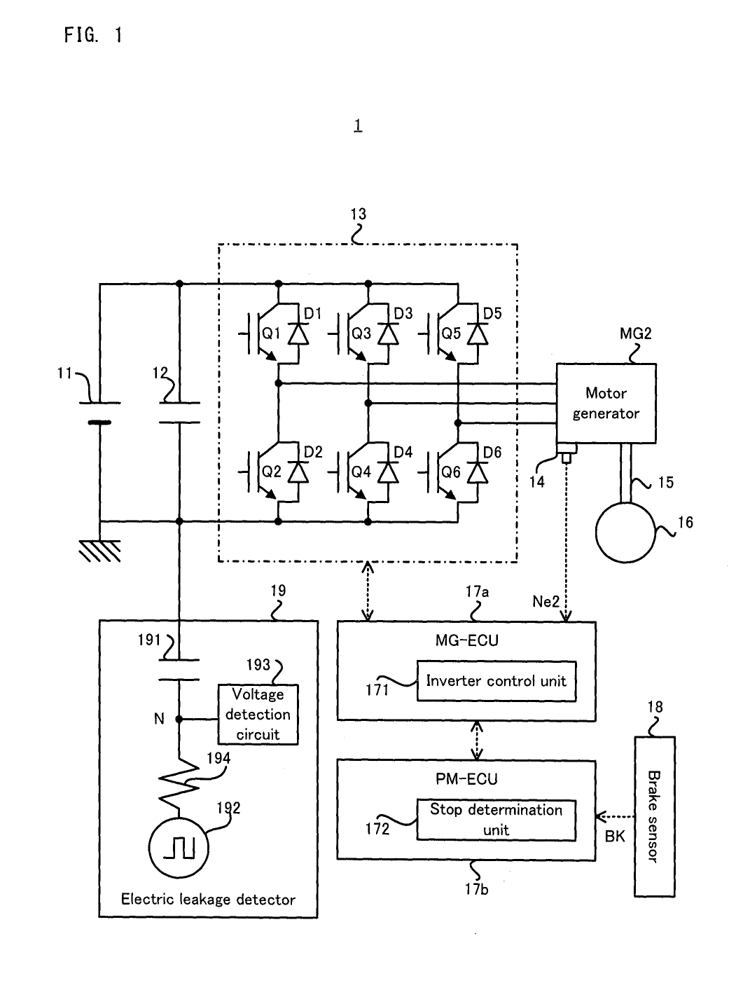

Firstly, with reference to FIG. 1 to FIG. 5, a first embodiment will be explained.

### (1-1) Configuration of Vehicle in First Embodiment

Firstly, with reference to FIG. 1, a configuration of a vehicle 1 in the first embodiment will be explained. FIG. 1 is a block diagram illustrating a configuration of a vehicle in a first embodiment.

As illustrated in FIG. 1, the vehicle 1 is provided with a direct current (DC) power supply 11, a smoothing capacitor 12, an inverter 13 which is one specific example of the “power converter”, a motor generator MG2 which is one specific example of the “three-phase alternating current (AC) motor”, a rotation angle sensor 14, a drive shaft 15, a driving wheel 16, a MG-ECU 17a which is one specific example of the “lower controlling device”, and a PM-ECU 17b which is one specific example of the “upper controlling device”, and a brake sensor 18 and an electric leakage detector 19.

The DC power supply 11 is a chargeable power storage apparatus. As an example of the DC power supply 11, for example, a secondary battery (e.g. a nickel-hydrogen battery, a lithium ion battery, etc.), a capacitor (e.g. an electric double layer capacitor, a large-capacity capacitor, etc.) are exemplified.

The smoothing capacitor 12 is a voltage smoothing capacitor connected between a positive line of the DC power supply 11 and a negative line of the DC power supply 11.

The inverter 13 converts DC power (or DC voltage) supplied from the DC power supply 11, to AC power (or three-phase AC voltage). In order to convert the DC power (or DC voltage) to the AC power (or three-phase AC voltage), the inverter 13 is provided with a U-phase arm including a p-side switching element Q1 and a n-side switching element Q2, a V-phase arm including a p-side switching element Q3 and a n-side switching element Q4, and a W-phase arm including a p-side switching element Q5 and a n-side switching element Q6. Each of the arms provided for the inverter 13 is connected in parallel between the positive line and the negative line. The p-side switching element Q1 and the n-side switching element Q2 are connected to in series between the positive line and the negative line. The same shall apply to the p-side switching element Q3 and the n-side switching element Q4, and the p-side switching element Q5 and the n-side switching element Q6. To the p-side switching element Q, a rectifier diode D1 is connected, wherein the rectifier diode D1 is configured to flow current from an emitter terminal of the p-side switching element Q1 to a collector terminal of the p-side switching element Q1. In the same manner, a rectifier diode D2 to a rectifier diode D6 are connected to the n-side switching element Q2 to the n-side switching element Q6, respectively. An intermediate point between an upper side arm (i.e. each p-side switching element) and a lower side arm (i.e. each n-side switching element) of each phase arm of the inverter 13 is connected to each phase coil of the motor generator MG2. As a result, the AC power (or three-phase AC voltage) generated as a result of the conversion operation by the inverter 13 is supplied to the motor generator MG2.

The motor generator MG2 is a three-phase AC motor generator. The motor generator MG2 is driven to generate torque required for the travel of the vehicle 1. The torque generated by the motor generator MG2 is transmitted to the driving wheel 16 via the drive shaft 15 mechanically coupled with the rotating shaft of the motor generator MG2. The motor generator MG2 may perform power regeneration (or power generation) when the vehicle 1 is braked.

The rotation angle sensor 14 detects the number of revolutions Ne2 of the motor generator MG2 (i.e. the number of revolutions of the rotating shaft of the motor generator MG2). The rotation angle sensor 14 preferably directly detects the number of revolutions Ne2 of the motor generator MG2. As one example of the rotation angle sensor 14 as described above, a resolver such as, for example, a rotary encoder is exemplified. The rotation angle sensor 14 preferably outputs the detected number of revolutions Ne2 to the MG-ECU 17a.

The MG-ECU 17a is an electronic control unit for controlling the motor generator MG2 and the inverter 13, and performs control according to a command from the PM-ECU 17b. The MG-ECU 17a is provided with an inverter control unit 171 as a physical, logical, or functional processing block.

The inverter control unit 171 is a processing block for controlling the operation of the inverter 13. The inverter control unit 171 may use a known control method to control the operation of the inverter 13. For example, the inverter control unit 171 may use, for example, a pulse width modulation (PWM) control method to control the operation of the inverter 13.

The PM-ECU 17b is an electronic control unit for controlling the operation of the vehicle 1 and is configured to output a command to each part including the MG-ECU 17a. The PM-ECU 17b in the embodiment is provided with a stop determination unit 172 which is one specific example of the “first determining device” and the “second determining device”, as a physical, logical, or functional processing block.

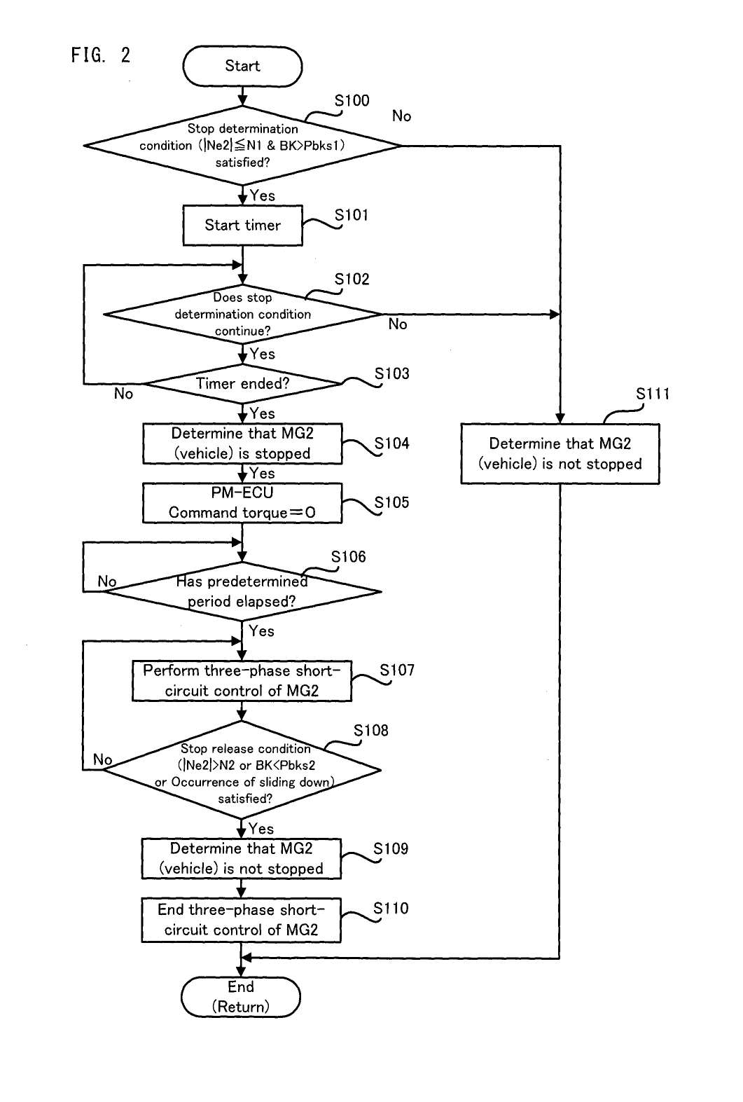

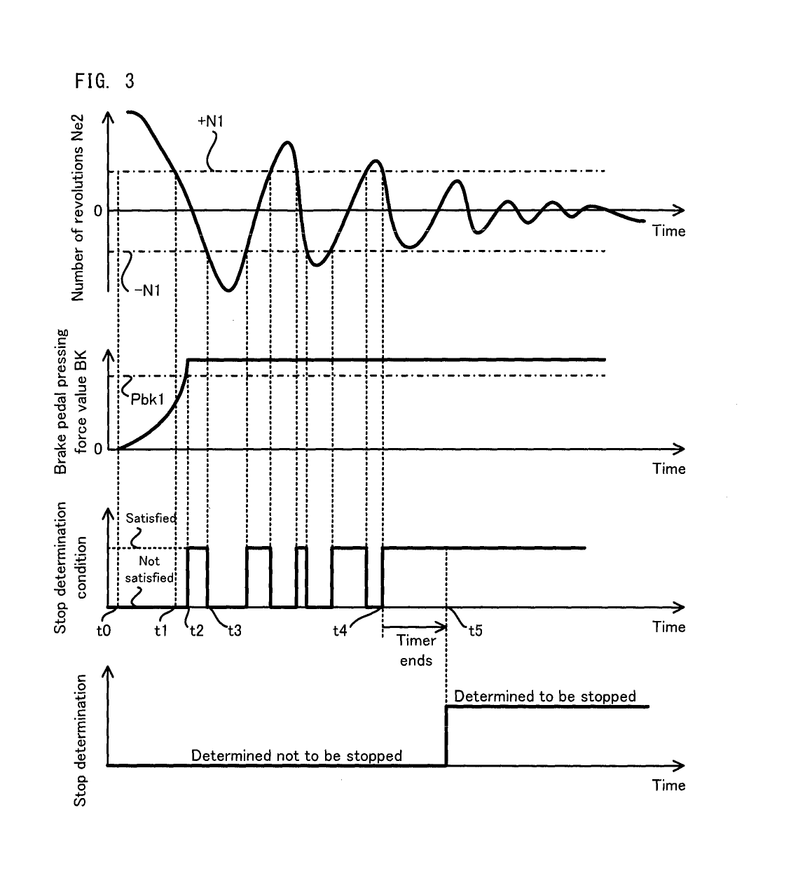

The stop determination unit 172 performs a stop determination operation for determining whether or not the motor generator MG2 is stopped. The stop determination operation will be detailed later (refer to FIG. 2 and FIG. 3), and the detailed explanation thereof is thus omitted here.

Considering that the drive shaft 15 of the vehicle 1 is coupled with the rotating shaft of the motor generator MG2, the number of revolutions of the drive shaft 15 of the vehicle 1 synchronizes with the number of revolutions Ne2 of the rotating shaft of the motor generator MG2. For example, the number of revolutions of the drive shaft 15 of the vehicle 1 is proportional to the number of revolutions Ne2 of the rotating shaft of the motor generator MG2. Therefore, if the number of revolutions Ne2 of the rotating shaft of the motor generator becomes zero in association with the stop of the motor generator MG2, the number of revolutions of the drive shaft 15 also becomes zero. The state in which the number of revolutions of the drive shaft 15 becomes zero is practically equivalent to a state in which the vehicle 1 is stopped. Thus, it can be said that the stop of the motor generator MG2 practically corresponds to the stop of the vehicle 1. The stop determination unit 172 may determine whether or not the vehicle 1 is stopped, in addition to or instead of determining whether or not the motor generator MG2 is stopped.

The brake sensor 18 detects a brake pedal pressing force value (i.e. a parameter which indicates a force to press a foot brake) BK. The brake sensor 18 preferably outputs the detected brake pedal pressing force value BK to the PM-ECU 17b.

The electric leakage detector 19 detects electric leakage of an electrical system (or a so-called motor drive system) including the DC power supply 11, the smoothing capacitor 12, the inverter 13 and the motor generator MG2.

In order to detect the electrical leakage, the electric leakage detector 19 is provided with a coupling capacitor 191, an oscillation circuit 192, a voltage detection circuit 193, and a resistor 194.

A method of detecting the electric leakage by the electric leakage detector 19 is as follows. Firstly, the oscillation circuit 192 outputs a pulse signal (or an AC signal) with a predetermined frequency. The voltage detection circuit 193 also detects the voltage of a node E which varies due to the pulse signal. Here, if there is the electric leakage in the electrical system, an electric leakage passage from the electrical system to a chassis ground (which is typically equivalent to a circuit including a resistor, or a circuit having a resistor and a capacitor which are connected in parallel) is formed. As a result, the pulse signal outputted by the oscillation circuit 192 is transmitted through the resistor 194, the coupling capacitor 191 and a passage reaching the electric leakage passage. Then, the voltage of the pulse signal of the node E is influenced by the impedance of the electric leakage passage (which is typically a resistance value of the resistor included in the equivalent circuit of the electric passage). Therefore, the detection of the voltage of the node E by the voltage detection circuit 193 allows the detection of the electric leakage.

### (1-2) Flow of Stop Determination Operation in First Embodiment

Next, with reference to FIG. 2, a flow of the stop determination operation performed in the vehicle 1 in the first embodiment (i.e. the stop determination operation performed by the PM-ECU 17b) and accompanying three-phase short-circuit control (i.e. a control operation of the inverter 13 performed by the MG-ECU 17a) will be explained. FIG. 2 is a flowchart illustrating the flow of the stop determination operation in the first embodiment.

As illustrated in FIG. 2, if the stop determination operation is started, the stop determination unit 172 determines whether or not a predetermined stop determination condition is satisfied (step S100).

The stop determination operation includes a stop determination condition based on the number of revolutions Ne2 of the motor generator MG2. In FIG. 2, as one example of the stop determination condition based on the number of revolutions Ne2, a condition in which the absolute value of the number of revolutions Ne2 of the motor generator MG2 is less than or equal to a threshold value N1 set on the threshold value setting unit 173 (i.e. |Ne2|≦N1 is satisfied) is used.

Moreover, the stop determination condition includes a stop determination condition based on the presence or absence of an operation which allows the vehicle 1 to be stopped (hereinafter, referred to as a “stop operation” as occasion demands). In FIG. 2, as one example of the stop determination condition based on the presence or absence of the stop operation, a condition in which the brake pedal pressing force value BK is greater than a predetermined threshold value Pbks1 (i.e. BK>Pbks1 applies) is used.

Incidentally, the stop operation is performed typically on the basis of a driver's intention (i.e. a driver's spontaneous operation). The stop operation may be automatically performed regardless of the driver's intention (e.g. automatically under the control by a control apparatus such as the ECU 17). The situation in which the stop operation is automatically performed can occur, for example, in the vehicle 1 in which automatic driving control (i.e. control for autonomously travelling the vehicle 1 regardless of the presence or absence of the driver's operation) is performed.

The stop determination condition illustrated in FIG. 2 is merely one example. Therefore, a stop determination condition different from the stop determination condition illustrated in FIG. 2 may also be used. For example, as long as it is possible to distinguish between the state in which the vehicle 1 is stopped and a state in which the vehicle 1 is not stopped depending on a difference in characteristics of the number of revolutions Ne2, an arbitrary condition using the difference in the characteristics of the number of revolutions Net may be used as the stop determination condition based on the number of revolutions Ne2. In the same manner, as long as it is possible to distinguish between the state in which the vehicle 1 is stopped and the state in which the vehicle 1 is not stopped depending on a difference in characteristics of the stop operation, an arbitrary condition using the difference in the characteristics of the stop operation may be used as the stop determination condition based on the presence or absence of the stop operation.

The stop determination condition based on the presence or absence of the stop operation is preferably a stop determination condition based on the presence or absence of an operation whose direct purpose is the stop of the vehicle 1. As one example of the operation whose direct purpose is the stop of the vehicle 1, for example, an operation in which a braking force can be applied to the vehicle 1 (e.g. an operation of operating an arbitrary brake such as a foot brake and a side brake) and an operation which is highly likely performed when the vehicle is stopped (e.g. an operation of moving a shift lever to a P range, etc.) are exemplified. Therefore, a condition in which the arbitrary brake is operated may be used as the stop determination condition based on the presence or absence of the stop operation. Alternatively, for example, a condition in which the braking force caused by the arbitrary brake is greater than a predetermined threshold value (e.g. the aforementioned condition in which the brake pedal pressing force value BK is greater than the predetermined threshold value Pbks1) may be used as the stop determination condition based on the presence or absence of the stop operation. Alternatively, for example, a condition in which the range of the shift lever is the P range may be used as the stop determination condition based on the presence or absence of the stop operation.

Incidentally, the stop determination condition based on the presence or absence of the stop operation may also be a stop determination condition based on the presence or absence of an operation which is not the operation whose direct purpose is the stop of the vehicle 1 but which can result in the stop of the vehicle 1. As one example of the operation which can result in the stop of the vehicle 1, an operation which is highly likely performed before the stop of the vehicle (e.g. an operation of releasing a foot from an accelerator pedal) is exemplified. Therefore, for example, a condition in which the accelerator pedal is not operated may be used as the stop determination condition based on the presence or absence of the stop operation.

Alternatively, the stop determination condition based on the presence or absence of the stop operation may be a condition related to the presence or absence of another operation caused by the stop operation. For example, as one example of the other operation caused by the stop operation, an operation of setting a torque command value of a creep to be zero and an operation of setting a torque command value of the motor generator MG2 to be zero are exemplified. Therefore, for example, a condition in which the torque command value of the creep is zero and a condition in which the torque command value of the motor generator MG2 is zero may be used as the stop determination condition based on the presence or absence of the stop operation.

As a result of the determination in the step S100, if it is determined that the predetermined stop determination condition is not satisfied (the step S100: No), the stop determination unit 172 determines that the motor generator MG2 is not stopped (step S111). Specifically, if it is determined that the absolute value of the number of revolutions Net of the motor generator MG2 is not less than or equal to the predetermined threshold value N1 (i.e. |Ne2|>N1), the stop determination unit 172 determines that the motor generator MG2 is not stopped. In the same manner, if it is determined that the brake pedal pressing force value BK is not greater than the predetermined threshold value Pbks1 (i.e. BK≦Pbks1), the stop determination unit 172 determines that the motor generator MG2 is not stopped.

If it is determined that the motor generator MG2 is not stopped, the PM-ECU 17b ends a series of operations. The ECU 17 may perform the operations subsequent to the step S100 again.

On the other hand, as a result of the determination in the step S100, if it is determined that the predetermined stop determination condition is satisfied (the step S100: Yes), the stop determination unit 172 starts a timer for measuring a predetermined period (step S101).

After starting the timer, the stop determination unit 172 determines whether or not the state in which the stop determination condition is satisfied continues (step S102).

As a result of the determination in the step S102, if it is determined that the state in which the stop determination condition is satisfied does not continue (the step S102: No), the stop determination unit 172 determines that the motor generator MG2 is not stopped (the step S111). In the other words, if it is determined that the stop determination condition is not satisfied before the end of the timer, the stop determination unit 172 determines that the motor generator MG2 is not stopped. To put it differently, if it is determined that the state in which the stop determination condition is satisfied does not continue over the predetermined period, the stop determination unit 172 determines that the motor generator MG2 is not stopped.

On the other hand, as a result of the determination in the step S102, if it is determined that the state in which the stop determination condition is satisfied continues (the step S102: Yes), the stop determination unit 172 repeats the operation of determining whether or not the state in which the stop determination condition is satisfied continues (the step S102) until the end of the timer (step S103).

After that, if the timer ends (the step S103: Yes), the stop determination unit 172 determines that the motor generator MG2 is stopped (step S104). In other words, if it is determined that the stop determination condition is satisfied between the start of the timer and the end of the timer, the stop determination unit 172 determines that the motor generator MG2 is stopped. To put it differently, if it is determined that the state in which stop determination condition is satisfied continues over the predetermined period, the stop determination unit 172 determines that the motor generator MG2 is stopped.

Now, with reference to FIG. 3, an explanation will be given to the operation of determining whether or not the motor generator MG2 is stopped, by using a specific example of the number of revolutions Ne2 and the brake pedal pressing force value BK. FIG. 3 is a timing chart illustrating the number of revolutions Ne2, the brake pedal pressing force value BK, the satisfaction or non-satisfaction of the stop determination condition, and the stop determination result of the vehicle 1.

As illustrated in FIG. 3, the brake pedal pressing force value BK increases in association with the start of the operation of the foot brake at a time point t0. With the increase in the brake pedal pressing force value BK, the number of revolutions Ne2 decreases.

If the vehicle 1 is about to stop due to the operation of the foot brake or the like, the drive shaft 15 of the vehicle 1 tends to have torsion. As a result, the torsion of the drive shaft 15 easily causes the hunting of the number of revolutions of the drive shaft 15. Considering that the rotating shaft of the motor generator MG2 is coupled with the drive shaft 15, the hunting of the number of revolutions Net of the motor generator MG2 also tends to occur. FIG. 3 illustrates the hunting of the number of revolutions Ne2 as described above (or an upper limit variation in the number of revolutions Ne2 which gradually converges in FIG. 3).

Then, at a time point t1, the absolute value of the number of revolutions Ne2 becomes less than or equal to the predetermined threshold value N1. At the time point t1, however, the brake pedal pressing force value BK is not greater than a predetermined threshold value Pbk1. Therefore, the stop determination condition is not satisfied.

Then, at a time point t2, the brake pedal pressing force value BK becomes greater than the predetermined threshold value Pbk1. Thus, at the time point t2, the stop determination condition is satisfied. At the time point t2, however, the state in which the stop determination condition is satisfied does not continue over predetermined period. Thus, the stop determination unit 172 does not determine that the motor generator MG2 is stopped.

Then, due to an influence of the hunting, at a time point t3 which is a time point before a lapse of the predetermined period from the time point t2 (i.e. a time point before the end of the timer which starts at the time point t2), the absolute value of the number of revolutions Ne2 exceeds the predetermined threshold value N1. In other words, at the time point t3, the stop determination condition is no longer satisfied. As a result, the stop determination unit 172 does not determine that the motor generator MG2 is stopped.

After that, until a time point t4, although the absolute value of the number of revolutions Ne2 becomes less than or equal to the predetermined threshold value N1, the state in which the stop determination condition is satisfied does not continue over the predetermined period. Therefore, in this case, the stop determination unit 172 does not determine that the motor generator MG2 is stopped.

Then, at the time point t4, the absolute value of the number of revolutions Ne2 becomes less than or equal to the predetermined threshold value N1 again. Thus, at the time point t4, the stop determination condition is satisfied. At the time point t4, however, the state in which the stop determination condition is satisfied does not continue over the predetermined period. Thus, the stop determination unit 172 does not determine that the motor generator MG2 is stopped.

Then, even at a time point t5 which is a time point after a lapse of the predetermined period from the time point t4 (i.e. a time point at the end of the timer which starts at the time point t2), the stop determination condition still remains satisfied. Thus, in the example illustrated in FIG. 3, for the first time at the time point t5, the stop determination unit 172 determines that the motor generator MG2 is stopped.

Back in FIG. 2, in the first embodiment, if the stop determination unit 172 determines that the motor generator MG2 is stopped (the step S104: Yes), a command for setting the torque of the motor generator MG2 to be zero is outputted from the PM-ECU 17b to the MG-ECU 17a. In other words, in order to perform the three-phase short-circuit control, the command torque of the PM-ECU 17b=0 is set (step S105).

Here, in particular, the MG-ECU 17a in the first embodiment does not perform the three-phase short-circuit control immediately after the reception of the command from the PM-ECU 17b, and waits for the predetermined period. Specifically, the MG-ECU 17a determines whether or not the predetermined period has elapsed after the reception of the command from the PM-ECU 17b (step S106). If it is determined that the predetermined period has elapsed (the step S106: Yes), the MG-ECU 17a performs the three-phase short-circuit control of the motor generator MG2 (step S107). In other words, the three-phase short-circuit control of the motor generator MG2 by the MG-ECU 17a is performed after a lapse of the predetermined period from the reception of the command from the PM-ECU 17b.

During the three-phase short-circuit control, the inverter control unit 171 of the MG-ECU 17a controls the operation of the inverter 13 to perform the three-phase short-circuit control in which the state of the motor generator MG2 is fixed in a three-phase short-circuit state. In other words, the inverter control unit 171 controls the operation of the inverter 13 such that all the switching elements of one of the upper side arms and the lower side arms are ON and that all the switching elements of the other of the upper side arms and the lower side arms are OFF. For example, the inverter control unit 171 may control the operation of the inverter 13 such that the p-side switching element Q1, the p-side switching element Q3 and the p-side switching element Q5 are ON and that the n-side switching element Q2, the n-side switching element Q4 and the n-side switching element Q6 are OFF.

In the step S107, however, the inverter control unit 171 may control the operation of the inverter 13 to perform two-phase short-circuit control in which the state of the motor generator MG2 is fixed in a two-phase short-circuit state. In other words, the inverter control unit 171 may control the operation of the inverter 13 such that any two switching elements of one of the upper side arms and the lower side arms are ON and that the remaining one switching element of the one of the upper side arms and the lower side arms and all the switching elements of the other of the upper side arms and the lower side arms are OFF. For example, the inverter control unit 171 may control the operation of the inverter 13 such that the p-side switching element Q1, the p-side switching element Q3 and the p-side switching element Q5 are ON and that the n-side switching element Q2, the n-side switching element Q4 and the n-side switching element Q6 are OFF.

Alternatively, in the step S107, the inverter control unit 171 may control the operation of the inverter 13 such that the state of the inverter 13 is fixed while only one of the six switching elements included in the inverter 13 is ON (and the remaining five switching elements are OFF).

Moreover, in the first embodiment, if it is determined that the motor generator MG2 is stopped, the electric leakage detector 19 may detect the electric leakage of the electrical system during the three-phase short-circuit control. Since at least one of the six switching elements included in the inverter 13 is ON, the electric leakage detector 19 can detect not only the electric leakage of a DC part (i.e. a circuit part on the DC power supply 11 side of the electrical system with respect to the inverter 13) but also the electric leakage of an AC part (i.e. a circuit part on the motor generator MG2 side of the electrical system with respect to the inverter 13).

In parallel with the operation in the step S107, the stop determination unit 172 determines whether or not a predetermined stop release condition is satisfied (step S108). In the first embodiment, the stop release condition includes a stop release condition based on the number of revolutions Ne2 of the motor generator MG2, a stop release condition based on the presence or absence of the stop operation, and a stop release condition based on the sliding-down determination of the vehicle, as in the stop determination condition. In FIG. 2, as one example of the stop release condition based on the number of revolutions Ne2, a condition in which the absolute value of the number of revolutions Ne2 of the motor generator MG2 is greater than a threshold value N2 set on the threshold value setting unit 173 (i.e. |Ne2|>N2 is satisfied) is used. In the same manner, as one example of the stop release condition based on the presence or absence of the stop operation, a condition in which the brake pedal pressing force value BK is less than a predetermined threshold value Pbks2 (i.e. BK<Pbks2 is satisfied) is used. The predetermined threshold value Pbks2 may be equal to or different from the predetermined threshold value Pbks1.

The stop release condition illustrated in FIG. 2 is merely one example. Therefore, a stop release condition different from the stop release condition illustrated in FIG. 2 may be used. The stop release condition may be determined from the same viewpoint as that of the stop determination condition, as occasion demands.

The stop determination unit 172 may determine, in the step S108, whether or not the corresponding stop determination condition is satisfied, in addition to or instead of determining whether or not the stop release condition based on the number of revolutions Ne2 of the motor generator MG2 or the stop release condition based on the presence or absence of the stop operation is satisfied. In this case, if it is determined that the stop determination condition is not satisfied, the subsequent operation may be performed in the same aspect as in the case where it is determined that the stop release condition is satisfied. On the other hand, if it is determined that the stop determination condition is satisfied, the subsequent operation may be performed in the same aspect as in the case where it is determined that the stop release condition is not satisfied.

As a result of the determination in the step S108, if it is determined that the stop release condition is not satisfied (the step S108: No), the inverter control unit 171 continues to control the operation of the inverter 13 to keep performing the three-phase short-circuit control. In the same manner, the electric leakage detector 19 may continue to detect the electric leakage of the electrical system.

On the other hand, as a result of the determination in the step S108, if it is determined that the stop release condition is satisfied (the step S108: Yes), the stop determination unit 172 determines that the motor generator MG2 is not stopped (step S109). In this case, the inverter control unit 171 may control the operation of the inverter 13 not to perform the three-phase short-circuit control in which the state of the motor generator MG2 is fixed in the three-phase short-circuit state (step S110). In the same manner, the electric leakage detector 19 may end the detection of the electric leakage of the electrical system.

After that, the MG-ECU 17a and the PM-ECU 17b end a series of operations. The MG-ECU 17a and the PM-ECU 17b, however, may perform the operations subsequent to the step S100 again.

As explained above, in the first embodiment, the stop determination unit 172 can determine whether or not the motor generator MG2 (or the vehicle 1) is stopped on the basis of both the stop determination condition based on the number of revolutions Net of the motor generator MG2 and the stop determination condition based on the presence or absence of the stop operation. The stop determination unit 172 can thus determine whether or not the motor generator MG2 (or the vehicle 1) is stopped, more accurately, in comparison with a stop determination unit 172a in a comparative example configured to determine whether or not the vehicle 1 is stopped on the basis of only the stop determination condition based on the number of engine revolutions. In addition, the stop determination unit 172 can determine whether or not the motor generator MG2 (or the vehicle 1) is stopped, more accurately, in comparison with a stop determination unit 172b in a comparative example configured to determine whether or not the motor generator MG2 (or the vehicle 1) is stopped on the basis of only the stop determination condition based on the number of revolutions Ne2 of the motor generator MG2. The reason will be explained hereinafter.

Firstly, an explanation will be given to the stop determination unit 172a in the comparative example configured to determine that the vehicle 1 is stopped if the number of engine revolutions is less than or equal to a predetermined threshold value, instead of the number of revolutions Ne2 of the motor generator MG2. The number of engine revolutions is typically calculated from a crank angle of the engine, instead of being detected by a detection mechanism configured to directly detect the number of revolutions. The crank angle of the engine is outputted from a crank angle sensor disposed in the engine. The accuracy of the number of engine revolutions calculated from the crank angle, however, is lower than the accuracy of the number of revolutions Ne2 of the motor generator MG2 detected by the rotation angle sensor 14 (i.e. a detection mechanism configured to directly detect the number of revolutions Ne2 of the motor generator MG2) in most cases. Thus, the stop determination unit 172a in the comparative example possibly erroneously determines that the vehicle 1 is stopped even though the vehicle is not stopped, due to an accuracy error of the number of engine revolutions calculated from the crank angle. Alternatively, the stop determination unit 172a in the comparative example possibly erroneously determines that the vehicle 1 is not stopped even though the vehicle is stopped.

In contrast, the stop determination unit 172 in the first embodiment can determine whether or not the motor generator MG2 (or the vehicle 1) is stopped on the basis of the number of revolutions Net of the motor generator MG2 detected by the rotation angle sensor 14. Considering that the accuracy of the number of revolutions Ne2 of the motor generator MG2 detected by the rotation angle sensor 14 is higher than the accuracy of the number of engine revolutions calculated from the crank angle, the stop determination unit 172 in the first embodiment can determine whether or not the motor generator MG2 (or the vehicle 1) is stopped, relatively accurately, in comparison with the stop determination unit 172a in the comparative example.

Moreover, an explanation will be given to the stop determination unit 172b in the comparative example configured to determine that the motor generator MG2 (or the vehicle 1) is stopped if the number of revolutions Ne2 of the motor generator MG2 is less than or equal to the predetermined threshold value N1 without determining whether or not the stop operation is performed. The stop determination unit 172b in the comparative example can supposedly determine whether or not the vehicle 1 is stopped, relatively accurately, in comparison with the stop determination unit 172a in the comparative example described above. The number of revolutions Ne2 of the motor generator MG2, however, may not be fixed (i.e. may vary) due to an influence of noise or the like which occurs in the rotation angle sensor 14. For example, although the actual number of revolutions of the motor generator MG2 is zero, the number of revolutions Net of the motor generator MG2 detected by the rotation angle sensor 14 possibly has a numerical value other than zero. Therefore, the stop determination unit 172b in the comparative example possibly erroneously determines that the motor generator MG2 (or the vehicle 1) is stopped even though the motor generator MG2 (or the vehicle 1) is not stopped, in some cases. Alternatively, the stop determination unit 172b in the comparative example possibly erroneously determines that the motor generator MG2 (or the vehicle 1) is not stopped even though the motor generator MG2 (or the vehicle 1) is stopped, in some cases.

In contrast, the stop determination unit 172 in the first embodiment can determine whether or not the motor generator MG2 (or the vehicle 1) is stopped on the basis of not only the number of revolutions Ne2 of the motor generator MG2 but also the presence or absence of the stop operation. Here, if the stop operation is performed, there is a high possibility that the motor generator MG2 (or the vehicle 1) is stopped. Thus, the stop determination unit 172 in the first embodiment can determine whether or not the motor generator MG2 (or the vehicle 1) is stopped, relatively accurately, in comparison with the stop determination unit 172b in the comparative example.

In addition, the stop determination unit 172 can determine that the motor generator MG2 (or the vehicle 1) is stopped if it is determined that the state in which the stop determination condition is satisfied continues over the predetermined period. Therefore, even if the number of revolutions Ne2 of the motor generator MG2 is subject to the hunting (or is not fixed, or varies), the stop determination unit 172 can determine whether or not the motor generator MG2 (or the vehicle 1) is stopped, more accurately.

Specifically, if the number of revolutions of the motor generator MG2 is subject to the hunting, a state in which the number of revolutions Ne2 is less than or equal to the predetermined threshold value N1 and a state in which the number of revolutions Ne2 is not less than or equal to the predetermined threshold value N1 appear alternately in a short time. If it is simply determined that the motor generator MG2 (or the vehicle 1) is stopped in the case where the number of revolutions Ne2 is less than or equal to the predetermined threshold value N1 under such circumstances, there is a high possibility that a determination result of whether or not the motor generator MG2 (or the vehicle 1) is stopped varies frequently.

In contrast, in the first embodiment, the stop determination unit 172 can determine that the motor generator MG2 (or the vehicle 1) is not stopped if it is determined that the number of revolutions Ne2 is less than or equal to the predetermined threshold value N1 only for a short time, due to the hunting or the like. On the other hand, the stop determination unit 172 can determine that the motor generator MG2 (or the vehicle 1) is stopped if it is determined that the number of revolutions Ne2 is less than or equal to the predetermined threshold value N1 for a long time to some extent due to the convergence of the hunting or the like. Therefore, the stop determination unit 172 can preferably determine whether or not the motor generator MG2 (or the vehicle 1) is stopped while suppressing the frequent variation in the determination result of whether or not the motor generator MG2 (or the vehicle 1) is stopped due to the influence of the hunting or the like.

In addition, the inverter control unit 171 in the first embodiment controls the inverter 13 to perform the three-phase short-circuit control while it is determined that the motor generator MG2 (or the vehicle 1) is stopped.

Here, during the three-phase short-circuit control, there is a possibility that electric power required to output the torque required for the travel of the vehicle 1 cannot be supplied from the inverter 13 to the motor generator MG2. It is therefore preferable that the inverter control unit 171 controls the inverter 13 to perform the three-phase short-circuit control while the motor generator MG2 (or the vehicle 1) is stopped. Conversely, the three-phase short-circuit control performed while the motor generator MG2 (or the vehicle 1) is not stopped likely influences the travel of the vehicle 1. Therefore, the inverter control unit 171 preferably controls the inverter 13 not to perform the three-phase short-circuit control while the motor generator MG2 (or the vehicle 1) is not stopped. Then, in the first embodiment, since the stop determination unit 172 can accurately determine whether or not the motor generator MG2 (or the vehicle 1) is stopped as described above, the inverter control unit 171 can control the inverter 13 to perform the three-phase short-circuit control while the motor generator MG2 (or the vehicle 1) is stopped. In other words, the inverter control unit 171 can control the inverter 13 to perform the three-phase short-circuit control at timing at which there is no possibility of influence on the travel of the vehicle 1.

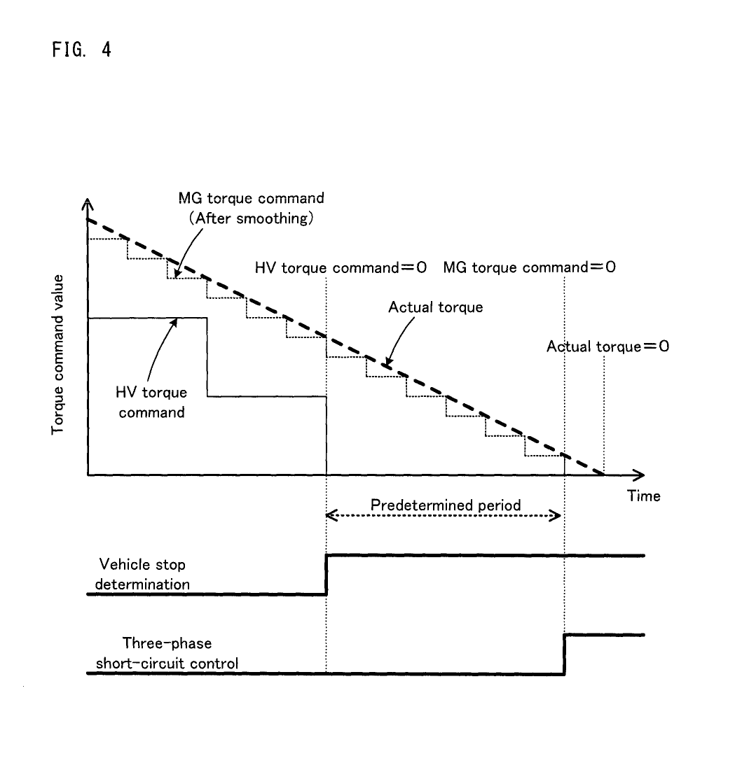

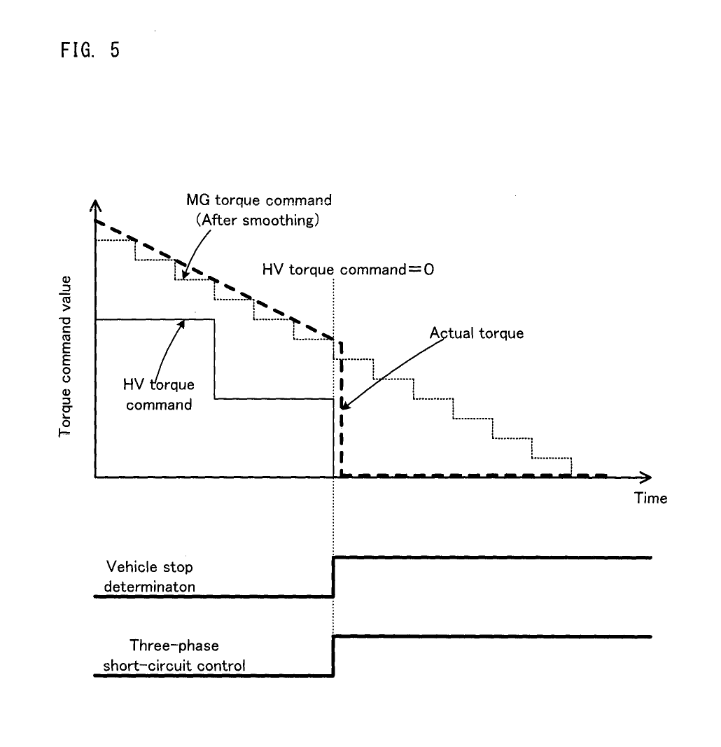

Moreover, particularly in the first embodiment, the three-phase short-circuit control by the MG-ECU 17a is performed after a lapse of the predetermined period from the setting that the command torque of the PM-ECU 17b=0, as described above. Hereinafter, an effect by the implementation of the control as described above will be explained with reference to FIG. 4 and FIG. 5. FIG. 4 is a chart illustrating changes in the torque command value and actual torque when the vehicle in the first embodiment stops. FIG. 5 is a chart illustrating changes in the torque command value and the actual torque when a vehicle in a first comparative example stops.

As illustrated in FIG. 4, when the vehicle 1 is stopped, the command torque from the PM-ECU 17b (hereinafter referred to as a “HV torque command” as occasion demands) decreases in stages towards 0. In the same manner, the command torque from the MG-ECU 17a (hereinafter referred to as a “MG torque command” as occasion demands) also decreases in stages towards 0. As is clear from the drawing, however, the MG torque command decreases while varying more finely than the HV torque command does, due to the smoothing or blurring effect by a filter. The MG torque command changes later than the HV torque command, due to a communication lag between the PM-ECU 17b and the MG-ECU 17a and an influence of the filter described above. The HV torque command and the MG torque command thus do not simultaneously become zero, and the MG torque command becomes zero the predetermined period later than the HV torque command.

Particularly in the first embodiment, the three-phase short-circuit control is performed after a lapse of the predetermined period (i.e. after the MG torque command=0) from the determination that the vehicle is stopped (i.e. from when the HV torque command=0).

On the other hand, as illustrated in FIG. 5, in the first comparative example in which the three-phase short-circuit control is performed before a lapse of the predetermined period, the three-phase short-circuit control is performed immediately after the determination that the vehicle is stopped (i.e. after the HV torque command=0). As described above, however, the MG torque command=0 is not satisfied at the time point at which the HV torque command=0, and apparently, the actual torque is not zero. Thus, in the first comparative example, the actual torque rapidly decreases at the start of the three-phase short-circuit control. The decrease in the actual torque as described above gives a sense of torque falling to the driver who wishes deceleration.

In contrast, in the first embodiment, as already explained, the three-phase short-circuit control is performed after the MG torque command=0. Thus, the rapid decrease in the actual torque caused by the three-phase short-circuit control does not occur. It is therefore possible to effectively prevent the occurrence of the sense of torque falling.

Incidentally, the predetermined period in the first embodiment may be set as the period from when the HV torque command=0 to when the MG torque command=0 as described above, but may be set as a period from when the HV torque command=0 to when the actual torque=0. In this manner, the occurrence of the sense of torque falling can be prevented, more certainly.

On the other hand, the electric leakage detector 19 in the first embodiment can detect the electric leakage while it is determined that the motor generator MG 2 (or the vehicle 1) is stopped (in other words, while the inverter 13 is controlled to perform the three-phase short-circuit control). Here, if the state of the inverter 13 varies while the electric leakage detector 19 detects the electric leakage, the state of the electrical system (e.g. the impedance of a passage including the electric leakage passage described above) possibly varies due to the variation in the state of the inverter 13. As a result, the electric leakage detector 19 possibly erroneously determines that the state variation caused by the variation in the state of the inverter 13 (e.g. the variation in voltage of the node E described above) is the state variation caused by the electric leakage. Therefore, from the viewpoint of improving the accuracy of the detection of the electric leakage by the electric leakage detector 19, it is preferable that the state of the inverter 13 is fixed in the three-phase short-circuit state (or in another state including the two-phase short-circuit state) while the electric leakage detector 19 detects the electric leakage.

Here, if the accuracy of the determination of whether or not the motor generator MG2 (or the vehicle 1) is stopped is relatively low, there is a higher possibility that the determination result of whether or not the motor generator MG2 (or the vehicle 1) is stopped varies frequently due to the noise and the hunting or the like described above, in comparison with a case where the determination accuracy is relatively high. As a result, the state of the inverter 13 also likely varies frequently due to the variation in the determination result of whether or not the motor generator MG2 (or the vehicle 1) is stopped. As a result, a period in which the state of the inverter 13 is fixed in the three-phase short-circuit state possibly becomes shorter than a period required to detect the electric leakage by the electric leakage detector 19.

For those reasons, if it is accurately determined whether or not the motor generator MG2 (or the vehicle 1) is stopped, the state of the inverter 13 is easily fixed in the three-phase short-circuit state. Then, in the first embodiment, as described above, the stop determination unit 172 can accurately determine whether or not the motor generator MG2 (or the vehicle 1) is stopped. Thus, while the electric leakage detector 19 detects the electric leakage, the possibility that the state of the inverter 13 is fixed (typically, fixed in a particular state) becomes relatively high. The electric leakage detector 19 can therefore preferably detect the electric leakage.

In the explanation described above, the vehicle 1 is provided with a single motor generator MG2. The vehicle 1, however, may be provided with a plurality of motor generators MG2. In this case, the vehicle 1 is preferably provided with the inverter 13 and the rotation angle sensor 14 for each of the motor generators MG2. Moreover, in this case, the ECU 17 may independently perform the aforementioned stop determination operation, for each of the motor generators MG2.

### (2) Second Embodiment

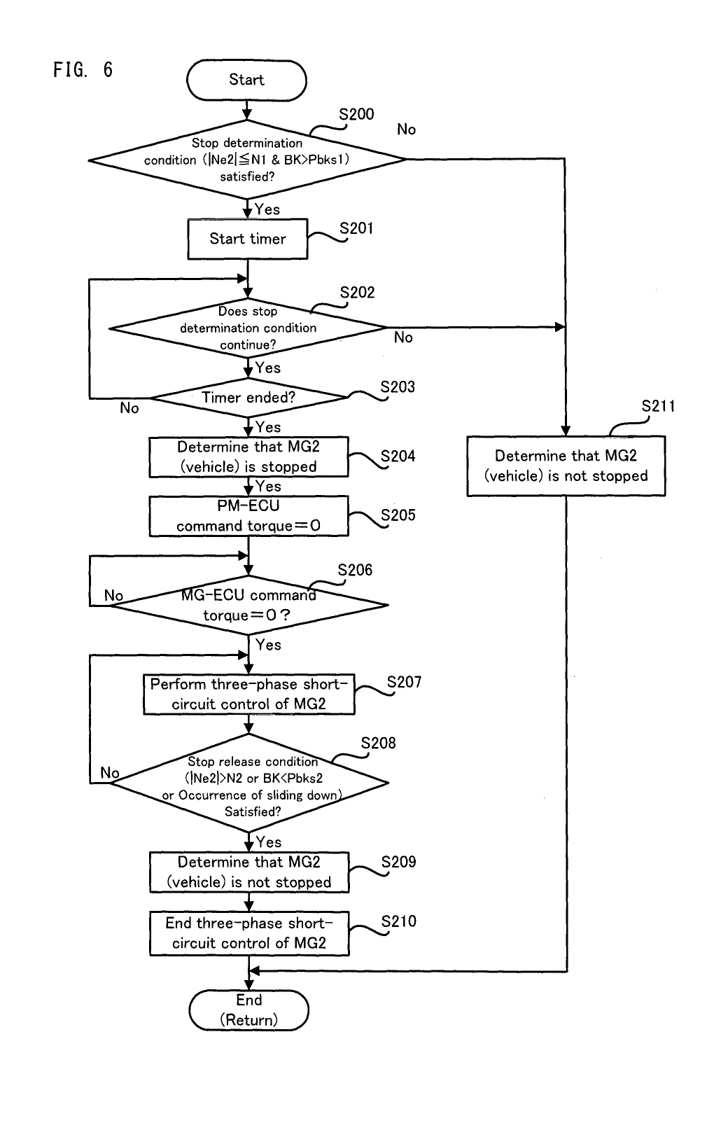

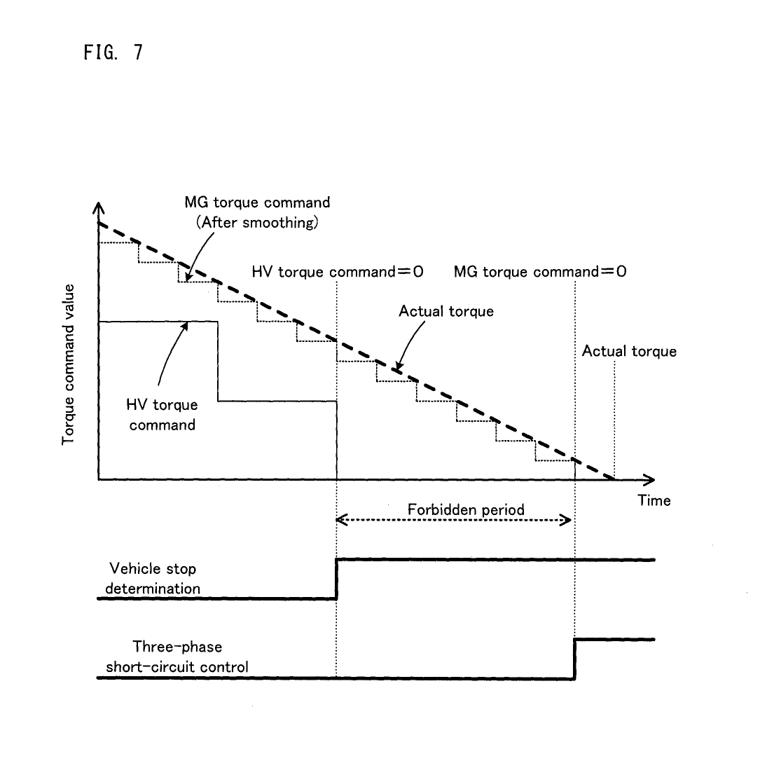

Next, a second embodiment will be explained with reference to FIG. 6 and FIG. 7. In the second embodiment, the operation is partially different from that of the first embodiment described above, and the other part is substantially the same. Thus, hereinafter, the different part from the first embodiment will be explained in detail, and the explanation of the duplicate part will be omitted as occasion demands.

Firstly, with reference to FIG. 6, a flow of the stop determination operation performed in the vehicle 1 in the second embodiment and accompanying three-phase short-circuit control will be explained. FIG. 6 is a flowchart illustrating the flow of the stop determination operation in the second embodiment.

As illustrated in FIG. 6, if the stop determination operation is started in the vehicle 1 in the second embodiment, the stop determination unit 172 performs each process, in order, from a step S200 to a step S204 which are the same as the step S100 to the step S104 in the first embodiment. In other words, if the stop determination condition continues, it is determined that the motor generator MG2 (or the vehicle) is stopped.

In the second embodiment, if it is determined on the stop determination unit 172 that the motor generator MG2 is stopped (the step S204: Yes), a command for setting the torque of the motor generator MG2 to be zero is outputted from the PM-ECU 17b to the MG-ECU 17a. In other words, in order to perform the three-phase short-circuit control, it is set such that the command torque of the PM-ECU 17b=0 (step S205).

In particular, the MG-ECU 17a in the second embodiment does not perform the three-phase short-circuit control immediately after receiving the command from the PM-ECU 17b, but if the command torque of the MG-ECU 17a becomes zero (step S206: Yes), the MG-ECU 17a in the second embodiment performs the three-phase short-circuit control of the MG2 (step S207). In other words, even if the command torque of the PM-ECU 17b becomes zero, the implementation of the three-phase short-circuit control is forbidden until the command torque of the MG-ECU 17a becomes zero. Incidentally, after the step S207, each process is performed in order from a step S208 to a step S210 which are the same as the step S208 to the step S110 in the first embodiment.

Hereinafter, an effect obtained by the operation described above will be explained with reference to FIG. 7. FIG. 7 is a chart illustrating changes in the torque command value and the actual torque when the vehicle in the second embodiment stops.

As illustrated in FIG. 7, due to the communication lag between the PM-ECU 17b and the MG-ECU 17a and the influence of the filter or the like, the HV torque command and the MG torque command do not simultaneously become zero, and the MG torque command becomes zero the predetermined period after the HV torque command becomes zero. Thus, if the three-phase short-circuit control is performed immediately after the HV torque command becomes zero, the actual torque rapidly decreases at the start of the three-phase short-circuit control, and the decrease in the actual torque gives the sense of torque falling to the driver who wishes deceleration (refer to FIG. 5).

In contrast, in the second embodiment, the three-phase short-circuit control is performed after the MG torque=0. In other words, even if the HV torque command becomes zero, the three-phase short-circuit control is forbidden until the MG torque command=0 (refer to a “forbidden period” in the drawing). As a result, the rapid decrease in the actual torque at the start of the three-phase short-circuit control is avoided. It is therefore possible to effectively prevent the occurrence of the sense of torque falling upon deceleration.

In the second embodiment, instead of using such a start condition of the three-phase short-circuit control that it is after the MG torque command=0, a start condition of after the actual torque=0 can also be used. In this manner, the occurrence of the sense of torque falling can be prevented, more certainly.

### (3) Third Embodiment

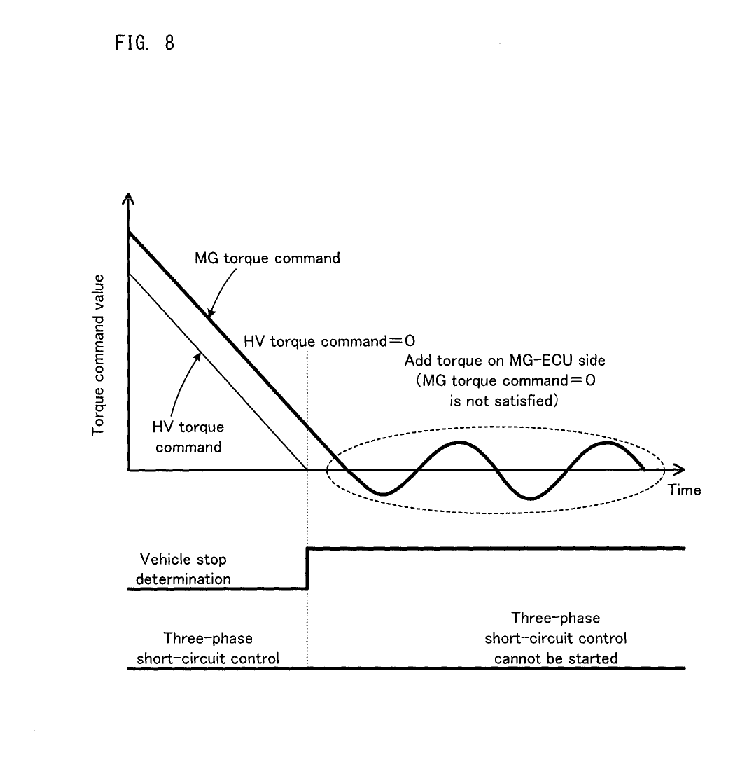

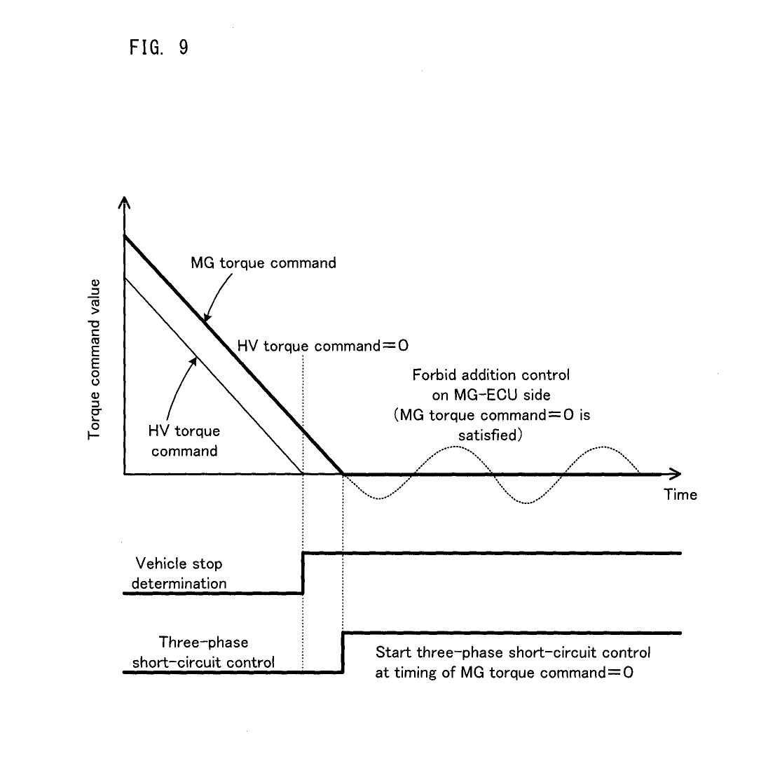

Next, a third embodiment will be explained with reference to FIG. 8 and FIG. 9. In the third embodiment, the operation is partially different from those of the first and second embodiments described above, and the other part is substantially the same. Thus, hereinafter, the different part from the first and second embodiments will be explained in detail, and the explanation of the duplicate part will be omitted as occasion demands.

In the third embodiment, the MG-ECU 17a is configured to perform addition control of the torque independently of the PM-ECU 17b. Hereinafter, the addition control will be specifically explained, and its possible problem will be explained by using a second comparative example illustrated in FIG. 8. FIG. 8 is a chart illustrating a change in the torque command value when a vehicle in a second comparative example stops. FIG. 8 illustrates as if the HV torque command and the MG torque command when the vehicle stops linearly decreased; however, apparently, the HV torque command and the MG torque command actually decrease in stages as illustrated in FIG. 4 and FIG. 7.

As illustrated in FIG. 8, the MG-ECU 17a in the second embodiment is configured to perform the addition control of the torque independently of the PM-ECU 17b. In other words, the MG-ECU 17a can perform the control for adding a torque value, as occasion demands, to the HV command torque value inputted from the PM-ECU 17b, and then can output a result as the MG torque command. Thus, the MG torque can vary even after the HV command torque becomes zero.

The addition control as described above is performed, for example, to reduce an influence of disturbance or the like. If, however, the addition control continues to be performed even after the HV command torque becomes zero, a situation in which the MG torque does not become zero even after the determination that the vehicle is stopped, can continue. Thus, for example, as in the second embodiment, if the three-phase short-circuit control is started after the MG torque=0, the start condition is never satisfied, and the three-phase short-circuit control is likely not performed.

Thus, in the third embodiment, the addition control for the MG command torque after the HV command torque becomes zero is temporarily forbidden. Hereinafter, the operation during the three-phase short-circuit control in the third embodiment will be explained with reference to FIG. 9. FIG. 9 is a chart illustrating a change in the torque command value when a vehicle in the third embodiment stops.

As illustrated in FIG. 9, in the third embodiment, the addition control for the MG command torque after the HV command torque becomes zero is temporarily forbidden. Thus, once the MG torque command becomes zero, it remains zero. Thus, the three-phase short-circuit control is performed at timing at which the MG command torque=0, which is the predetermined period after the HV command torque becomes zero. Thus, even in the configuration that the addition control by the MG-ECU 17a can be performed, it is possible to preferably perform the three-phase short-circuit control.

The addition control is preferably forbidden until the end of the three-phase short-circuit control. Another condition can also be set as a release condition of the addition control forbidding.

### (4) Fourth Embodiment

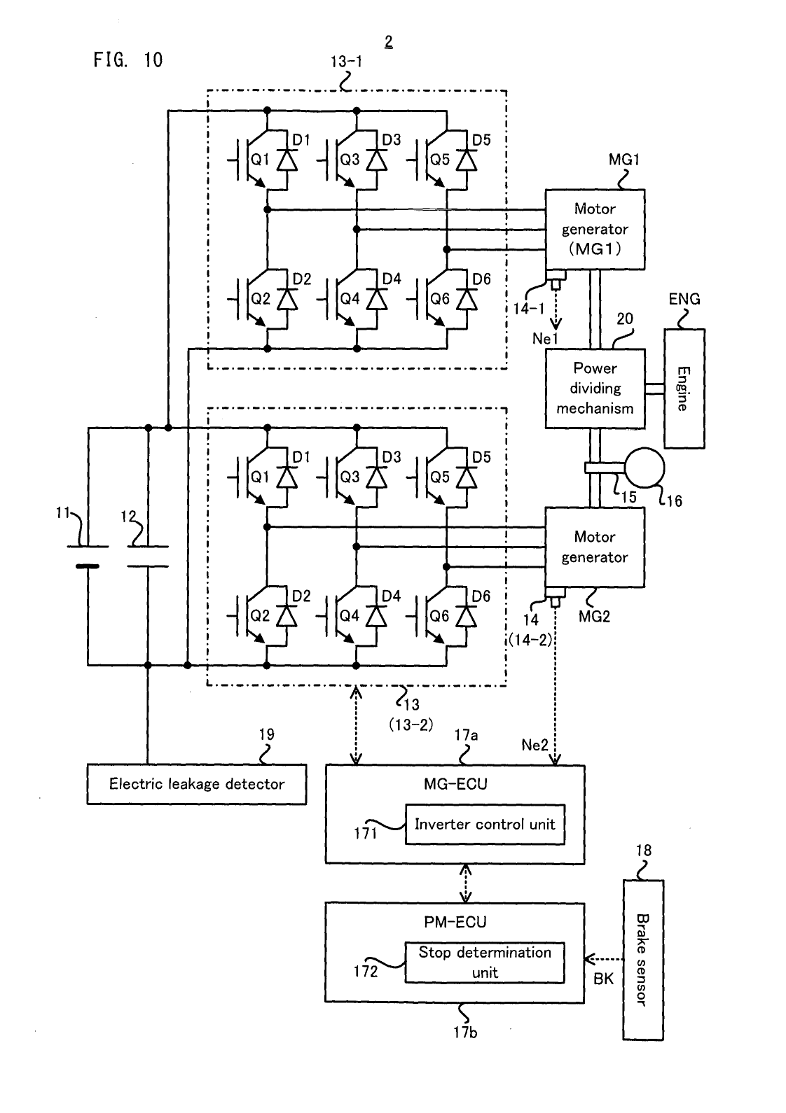

Next, a fourth embodiment will be explained with reference to FIG. 10. In the fourth embodiment, the operation is partially different from those of the first, second and third embodiments described above, and the other part is substantially the same as those of the first, second and third embodiments. Thus, hereinafter, the different part from the first, second and third embodiments will be explained in detail, and the explanation of the duplicate part will be omitted as occasion demands.

In particular, the fourth embodiment is different from the first and third embodiments in the configuration of a power engine. Thus, firstly, with reference to FIG. 10, a configuration of a vehicle 2 in the fourth embodiment will be explained. FIG. 10 is a block diagram illustrating the configuration of the vehicle in the fourth embodiment.

As illustrated in FIG. 10, the vehicle 2 in the fourth embodiment is different from the vehicle 1 in the first embodiment illustrated in FIG. 1 in that an engine ENG, a motor generator MG1, and inverter 13-1, a rotation angle sensor 14-1, and a power dividing mechanism 20 are further provided. The other constituents of the vehicle 2 in the fourth embodiment are the same as those of the vehicle 1 in the first embodiment. For convenience of explanation, however, in the fourth embodiment, the inverter 13 in the first embodiment is referred to as an inverter 13-2, and the rotation angle sensor 14 in the first embodiment is referred to as a rotation angle sensor 14-2. To simplify the drawing, the detailed configuration of the electric leakage detector 19 is omitted in FIG. 10; however, apparently, the electric leakage detector 19 in the fourth embodiment is the same as the electric leakage detector 19 in the first embodiment.

The inverter 13-1 is connected in parallel with the inverter 13-2. The inverter 13-1 converts AC power (or three-phase AC voltage) generated by regenerative power generation by the motor generator MG1, to DC power (or DC voltage). As a result, the DC power supply 11 is charged by the DC power (or DC voltage) generated as a result of the conversion operation by the inverter 13-2. Since the configuration of the inverter 13-1 is the same as that of the inverter 13-2, the detailed explanation of the configuration of the inverter 13-1 is omitted.

The motor generator MG1 is a three-phase AC motor generator. The motor generator MG1 performs power regeneration (or power generation) when the vehicle 1 is braked. The motor generator MG1 may be driven to generate torque required for the travel of the vehicle 2.

The rotation angle sensor 14-1 detects the number of revolutions Ne1 of the motor generator MG1 (i.e. the number of revolutions of the rotating shaft of the motor generator MG1). The rotation angle sensor 14-1 may be the same as the rotation angle sensor 14-2.

The engine ENG is an internal combustion engine such as a gasoline engine, and functions as a main power source of the vehicle 2.

The power dividing mechanism 20 is a planetary gear mechanism provided with a sun gear, a planetary carrier, a pinion gear, and a ring gear which are not illustrated. The power dividing mechanism 20 mainly divides the power of the engine ENG into two systems (i.e. a power system transmitted to the motor generator MG1 and a power system transmitted to the drive shaft 15).

In the fourth embodiment, an example in which the vehicle 2 adopts a so-called split (or power division) type hybrid system (e.g. THS: Toyota Hybrid System) is explained. The vehicle 2, however, may adopt a series type or a parallel type hybrid system.

As described above, even in the vehicle 2 provided with the motor generator MG1 and the engine ENG as the power source, the stop control can be preferably performed by performing the same control as in the first to third embodiments described above. In other words, it is possible to preferably perform the stop control while preventing the occurrence of the sense of torque falling, by performing the stop determination on the basis of the number of revolutions Net of the motor generator MG2 and the presence or absence of the stop operation and by performing the three-phase short-circuit control of the motor generator MG2 at proper timing.

In addition, particularly in the fourth embodiment, parameters regarding the motor generator MG1 and the engine ENG may be considered in the stop determination described above. Specifically, in addition to the rotation angle and the number of revolutions of the motor generator MG2, the rotation angle and the number of revolutions of the motor generator MG1 and the engine ENG may be considered to perform the stop determination. In this manner, the accuracy of the stop determination can be further improved.

Moreover, in the fourth embodiment, in addition to the three-phase short-circuit control of the motor generator MG2, the three-phase short-circuit control of the motor generator MG1 may be performed. Even in this case, if the parameters regarding the motor generator MG1 and the engine ENG are considered in addition to the parameter regarding the motor generator MG2, the three-phase short-circuit control can be performed at preferable timing.

As explained above, in the fourth embodiment, as in the first to third embodiments described above, it is possible to prevent that the three-phase short-circuit control is performed at improper timing. It is therefore possible to preferably perform the stop control while preventing the occurrence of the sense of torque falling.

The present invention is not limited to the aforementioned embodiments, but various changes may be made, if desired, without departing from the essence or spirit of the invention which can be read from the claims and the entire specification. A vehicle control apparatus, which involves such changes, is also intended to be within the technical scope of the present invention.

### DESCRIPTION OF REFERENCE NUMERALS AND LETTERS

1, 2 vehicle
13 inverter
14 rotation angle sensor
15 drive shaft
17a MG-ECU
17b PM-ECU
171 inverter control unit
172 stop determination unit
19 electric leakage detector
MG1, MG2 motor generator
ENG engine
Q1 to Q6 switching element
Ne2 number of revolutions
BK brake pedal pressing force value

1. A vehicle control apparatus configured to control a vehicle, the vehicle comprising: a three-phase alternating current motor configured to drive at the number of revolutions which synchronizes with the number of revolutions of a drive shaft of the vehicle; and a power converter comprising first switching elements and second switching elements for respective three phases of the three-phase AC motor, each first switching element and each second switching element being connected in series, the power converter being configured to convert electric power supplied to the three-phase AC motor from direct current power to AC power, said vehicle control apparatus comprising:
an upper controlling device configured to output a command for controlling an operation of the three-phase AC motor; and
a lower controlling device configured to control the operation of the three-phase AC motor by controlling a state of the power converter according to the command outputted from the upper controlling device, wherein
said upper controlling device has:
a first determining device configured to determine whether or not the number of revolutions of the three-phase AC motor is less than or equal to a predetermined threshold value and whether or not a stop operation which can stop the vehicle is performed;
a second determining device configured to determine that the vehicle is stopped if the first determining device determines that the number of revolutions of the three-phase AC motor is less than or equal to the predetermined threshold value and that the stop operation is performed;
a commanding device configured to output to said lower controlling device a particular control command for setting the state of the power converter to a particular state in which all of one of the first switching elements and the second switching elements are OFF and at least one of the other of the first switching elements and the second switching elements is ON, if the second determining device determines that the vehicle is stopped, and
said lower controlling device controls the power converter to be in the particular state after a lapse of a predetermined period from reception of the particular control command.

2. The vehicle control apparatus according to claim 1, wherein said lower controlling device performs the control to set torque of the three-phase AC motor to be zero after the reception of the particular control command, and then performs the control to set the power converter to be in the particular state.

3. The vehicle control apparatus according to claim 2, wherein
said lower controlling device has an addition controlling device configured to perform addition control for adding the torque of the motor, independently of the command from said upper controlling device, and
the addition controlling device stops the addition control until the control for setting the power converter to be in the particular state if the particular control command is received.
